(19) United States
(12) Patent Application Publication
(10) Pub. No.: US 2026/0248685 A1
(43) Pub. Date: Aug. 27, 2026

(54) PRESSURE POINT STIMULATION APPARATUS

(71) Applicant: Toyota Research Institute, Inc., Los Altos, CA (US)

(72) Inventor: Alessandra Lozano, Lexington, KY (US)

(73) Assignees: Toyota Research Institute, Inc., Los Altos, CA (US); Toyota Jidosha Kabushiki Kaisha, Aichi-ken (JP)

(21) Appl. No.: 19/061,602

(22) Filed: Feb. 24, 2025

(51) Int. Cl. A61H 39/04

(52) U.S. Cl. CPC A61H 39/04; A61H 2201/1638; A61H 2201/5043; A61H 2205/06

(57) ABSTRACT

A pressure point stimulation apparatus includes a wristband and a first pressure point node attached to the wristband. The pressure point stimulation apparatus includes an arm supported by the wristband, the arm having a plurality of segments with an arm hinge between each segment. The pressure point stimulation apparatus includes a second pressure point node attached to the arm.

### TECHNICAL FIELD

The present specification generally relates to apparatuses for providing therapeutic relief and, more specifically, apparatuses for applying pressure to multiple pressure points.

### BACKGROUND

Application of pressure to certain points on a human body, known as pressure points, is generally understood to provide therapeutic relief, such as reduction of stress, anxiety, pain, and the like. Various mechanical devices exists that allow a user to apply pressure to certain pressure points. However, current devices are limited in the amount and/location of pressure points they can apply pressure to.

Accordingly, a need exists for improved pressure point stimulation apparatuses that can apply pressure to multiple pressure points.

### SUMMARY

In one embodiment, a pressure point stimulation apparatus includes a wristband. The pressure point stimulation apparatus includes a first pressure point node attached to the wristband. The pressure point stimulation apparatus includes an arm supported by the wristband, the arm having a plurality of segments with an arm hinge between each segment. The pressure point stimulation apparatus includes a second pressure point node attached to the arm.

In another embodiment, a pressure point stimulation apparatus includes a wristband. The pressure point stimulation apparatus includes a first arm supported by the wristband, the first arm having a plurality of segments with an arm hinge between each segment. The pressure point stimulation apparatus includes a first pressure point node attached to the arm. The pressure point stimulation apparatus includes a second arm supported by the wristband, the second arm having a plurality of segments with an arm hinge between each segment. The pressure point stimulation apparatus includes a second pressure point node attached to the second arm.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a pressure point stimulation apparatus, according to one or more embodiments shown and described herein;

FIG. 2 schematically depicts a cross-section of a base of the pressure point stimulation apparatus, according to one or more embodiments shown and described herein;

FIG. 3 schematically depicts a block diagram of components of the pressure point stimulation apparatus, according to one or more embodiments shown and described herein; and

FIG. 4 schematically depicts a perspective view of the pressure point stimulation apparatus as worn on a hand and wrist of a user, according to one or more embodiments shown and described herein.

### DETAILED DESCRIPTION

Embodiments described herein are directed to a pressure point stimulation apparatus that includes a wristband, one or more multi-segmented and hinged arms supported by the wristband, and a plurality of pressure point nodes supported by the wristband and/or arms. The pressure point stimulation apparatus can be worn on a wrist of a user and adjusted by moving the wristband and/or arms such that the plurality of pressure point nodes apply pressure to multiple pressure points of the user. Various embodiments of the pressure point stimulation apparatus and the operation of the pressure point stimulation apparatus are described in more detail herein. Whenever possible, the same reference numerals will be used throughout the drawings to refer to the same or like parts.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural referents unless the context clearly dictates otherwise. Thus, for example, reference to “a” component includes aspects having two or more such components, unless the context clearly indicates otherwise.

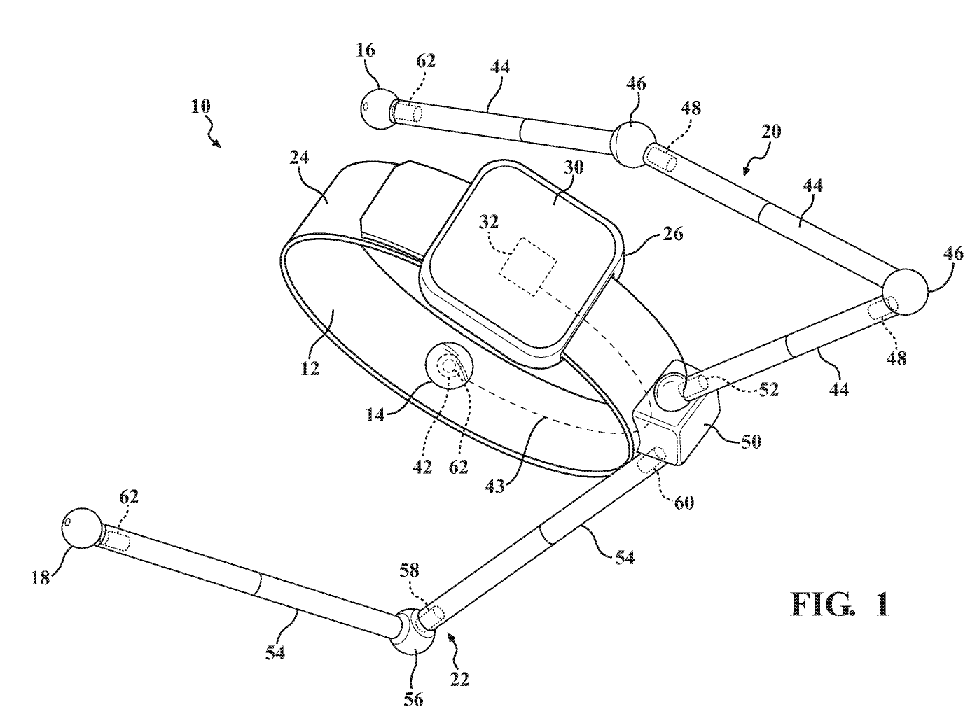

Referring now to FIG. 1, an apparatus 10 for providing pressure point stimulation is illustrated according to one or more embodiments described herein. The apparatus 10 may generally include a wristband 12 that supports a plurality of pressure point nodes 14, 16, 18, e.g., a first pressure point node 14, a second pressure point node 16, and a third pressure point node 18. The first pressure point node 14 may be attached to the wristband 12. The apparatus 10 may include a first arm 20 supported by the wristband 12 with the second pressure point node 16 attached to the first arm 20. The apparatus 10 may include a second arm 22 supported by the wristband 12 with the third pressure point node 18 attached to the second arm 22. The apparatus 10 may be configured, e.g., the wristband 12, the first arm 20, and the second arm 22 may be adjusted, such that the pressure point nodes 14, 16, 18 apply pressure to pressure points of a user of the apparatus 10.

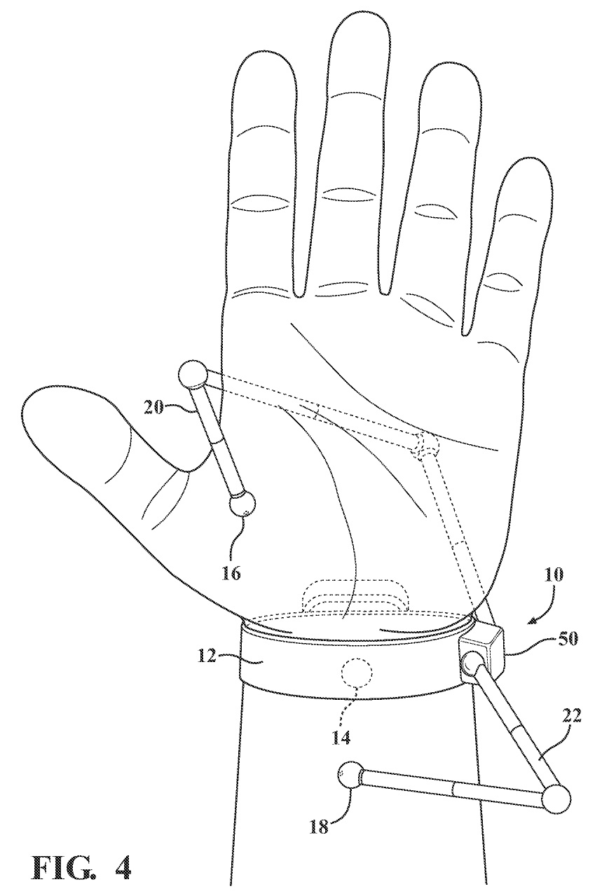

The wristband 12 is included in the apparatus 10 to enable securement of the apparatus 10 to a user, e.g., the wristband 12 may be worn on a wrist of the user, e.g., as shown in FIG. 4. The wristband 12 includes a strap 24 that is of sufficient length to surround a wrist, e.g., a typically sized human wrist. The strap 24 may be formed of a woven fabric, rubber, flexible plastic, leather, a flat webbing, a tubular webbing, and/or other suitable material. The wristband 12 may include multiple layers, e.g., laminated or sewn together. The wristband 12 may be variable in size to enable use by users having different sized wrists. The wristband 12 may include structure attached to the strap 24 that can vary a circumference of the strap 24 encircling the wrist. For example and without limitation, hook and loop structures (e.g., Velcro), buckles, and/or other structure suitable for changing circumference size of the wristband 12 may be attached to the strap 24.

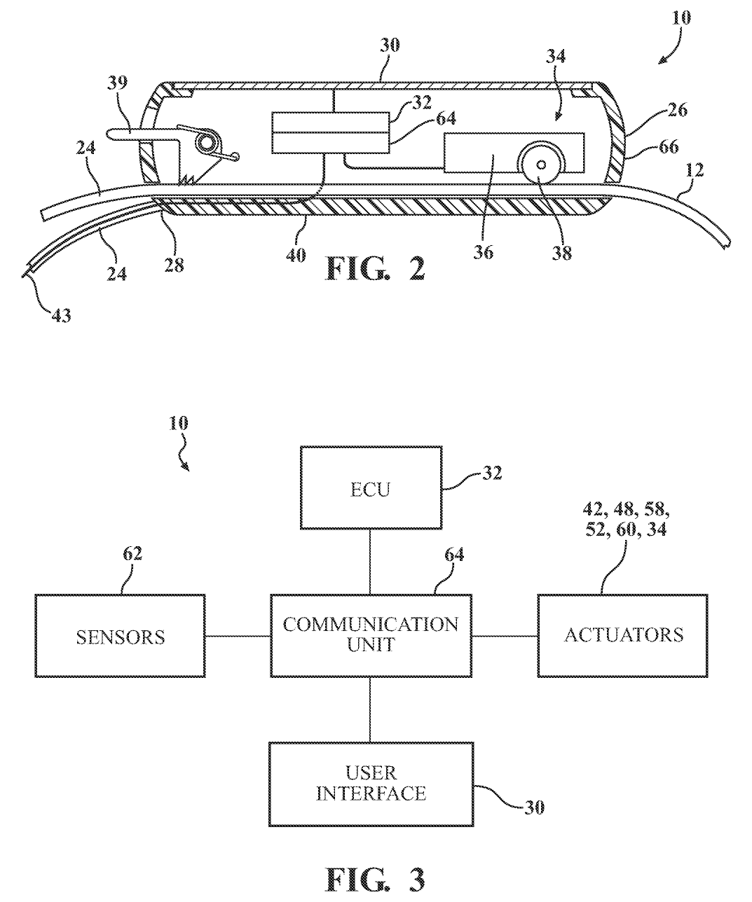

The wristband 12 is included in the apparatus 10 to support, i.e., bear the weight of, other components of the apparatus 10, e.g., the pressure point nodes 14, 16, 18 and the arms 20, 22. The wristband 12 may include a base 26 connected to the strap 24. The base 26 may be connected to the strap 24 such that the strap 24 forms a loop to be worn around a user’s wrist. For example and without limitation, and with reference to FIG. 2, a first end 28 of the strap 24 may be fixed to the base 26. The strap 24 may extend away from the first end 28 and be slidably received, and selectively fixed, to the base 26. In other words, the base 26 may function as a buckle to adjust a size of the loop formed by the strap 24. The base 26 may provide for attachment of components, such as a user interface 30, to the wristband 12. The base 26 may further enclose and protect certain components of the apparatus 10, such an electronic control unit (ECU) 32, a power source, one or actuators 34, etc., and e.g., as described below.

With reference to FIG. 2, the wristband 12 may be actuatable, e.g., in response to receiving a command from the ECU 32, to decrease a circumference of the wristband 12. For example, and without limitation, the base 26 may include an actuator 34 having a motor and reduction gear set 36, wheel 38, ratchet and paw mechanism 39, and/or other mechanical and/or electromechanical structure that can move the strap 24 in a tightening direction. For example, the strap 24 may be slidably disposed within the base 26 and compressed between a floor 40 of the base 26 and the wheel 38 of the actuator 34. Torque from the motor and reduction gear set 36 in a certain direction may rotate the wheel 38, causing the strap 24 to move along the floor 40 of the base 26 and decrease the circumference of the wristband 12. The ratchet and paw mechanism 39 of the actuator 34 may secure the tightened strap 24. The actuator 34 may include any other additional and/or alterative structure to move and/or secure the strap 24 relative to the base 26, e.g., a linear actuator, a motorized retractable spool and cable, or the like.

Returning to FIG. 1, the first pressure point node 14 is included in the apparatus 10 to apply pressure to a certain point on a user of the apparatus 10. For example, when the wristband 12 is worn at a certain position on the wrist of the user, the first pressure point node 14 may apply pressure to the great abyss pressure point. The great abyss pressure point is located in the wrist crease on the anterior forearm between the radial bone and the first metacarpal bone, between the radial artery and the tendon that abducts the thumb. The first pressure point node 14 may include a rubber protrusion, e.g., having a hemisphere shape. The first pressure point node 14 may be any other suitable shape and/or material sufficient for applying pressure at human pressure points.

The first pressure point node 14 may be attached to the wristband 12. For example, the first pressure point node 14 may be fixed to the strap 24. The first pressure point node 14 may be fixed to the strap 24 with via fastener, adhesive, interference fit, being sewn in, being embedded in, etc. As another example, the first pressure point node 14 may be fixed to the base 26, e.g., at a bottom surface of the base 26 that faces the wrist of the user (not shown).

The wristband 12 may be actuated to increase pressure applied by the first pressure point node 14, e.g., in response to a command from the ECU 32. Actuation of the wristband 12 to increase pressure applied by the first pressure point node 14 may include decreasing a circumference of the wristband 12. For example, the actuator 34 at the base 26 may retract the strap 24 to decrease the circumference of the wristband 12. As another example, the wristband 12 and/or the first pressure point node 14 may include an actuator 42, such as a bladder or linear actuator, disposed underneath the first pressure point node 14 that urges the first pressure point node 14 upward. The actuator 42 disposed underneath the first pressure point node 14 may be communicatively coupled to the ECU 32. As used herein, the term “communicatively coupled” means that coupled components are capable of exchanging data signals with one another such as, for example, electrical signals via conductive medium, electromagnetic signals via air, optical signals via optical waveguides, and the like. For example, and without limitation, conductive wires 43 may extend from the ECU 32 in the base 26 to the actuator 42 internally though the strap 24, e.g., between layers of the strap 24, through an internal passage of a tubular webbing, etc. As another example, the actuator 42 may be communicatively coupled with the ECU 32 via a communication unit 64, discussed below.

The second pressure point node 16 is included in the apparatus 10 to apply pressure to a certain point on a user of the apparatus 10. For example, when the wristband 12 is worn at a certain position on the wrist of the user and the first arm 20 of the apparatus 10 is in a certain configuration, the second pressure point node 16 may apply pressure to the union valley pressure point. The union valley pressure point is located on the web between the thumb and index finger. The second pressure point node 16 may include a rubber protrusion, e.g., having a hemisphere shape. The second pressure point node 16 may be any other suitable shape and/or material sufficient for applying pressure at human pressure points. The second pressure point node 16 is attached to the first arm 20, e.g., at a distal end of the first arm 20. The second pressure point node 16 may be fixed to the distal end of the first arm 20, e.g., with adhesive, a fastener, interference fit, and/or other suitable structure.

The first arm 20 may include a plurality of segments 44 with an arm hinge 46 between each segment 44 such that the first arm 20 can move with multiple degrees of freedom to position the second pressure point node 16. The segments 44 of the first arm 20 may be plastic, metal, or other material of sufficient strength and rigidity to perform as described herein. The segments 44 may be hollow with open ends, e.g., such that wiring or the like can be routed through the segments 44. In the example apparatus 10 shown in the FIGS., the first arm 20 includes three segments 44, e.g., to enable to the second pressure point node 16 to reach the union valley pressure point. It is to be understood that the first arm 20 may include more or less segments 44, e.g., two, four, etc.

The arm hinges 46 permit pivot movement of the segment 44 on one side of the arm hinge 46 relative to the segment 44 on the other side of the arm hinge 46. In other words, the arm hinges 46 may permit change of a pivot angle defined between two adjacent segments 44. The arm hinges 46 may only permit pivot movement upon application of sufficient force to one or more of the segments 44. For example, the arm hinges 46 may include fiction pads or other suitable structure that resists movement. The arm hinges 46 may be rotatable relative to the segments 44 attached thereto. For example, the arm hinges 46 may be rotatably connected at ends of the segments 44 such that the arm hinges 46 can rotate about an axis extending from the ends to opposite ends of the respective segments 44 to change a rotational position of the arm hinge 46.

The apparatus 10 may include one or more actuators 48 configured to actuate the hinges 46 between the segments 44 of the first arm 20. For example, an actuator 48 may be at each of the hinges 46 of the first arm 20, e.g., to control a pivot angle and/or rotational position at the respective hinge 46. The actuators 48 may include motors, gear reduction sets, linear actuators, servos, and/or other mechanical or electromechanical structure for pivoting one segment 44 relative to another segment 44 about the hinge 46 therebetween and/or for rotating the hinge 46 relative to one of such segments 44. The actuators 48 may be communicatively coupled with the ECU 32. The actuators 48 may move the hinges 46, e.g., to a certain pivot angle and/or rotational position and in response to a command from the ECU 32.

The first arm 20 is supported by the wristband 12. In other words, weight of the first arm 20 is borne by the wristband 12. For example, the first arm 20 may be attached to a wrist hinge 50 that is attached to the wristband 12. The first arm 20 my pivot relative to the wristband 12 at the wrist hinge 50, and may rotate relative to the wristband 12 at the wrist hinge 50. The wrist hinge 50 may only permit pivot and/or rotation movement upon application of sufficient force to the first arm 20. For example, the wrist hinge 50 may include fiction pads or other suitable structure that resists movement. In the example provided, the wrist hinge 50 may be fixed to the strap 24. As another example, the wrist hinge 50 may be fixed to the base 26, or other suitable structure of the wristband 12.

The apparatus 10 may include one or more actuators 52 configured to move the first arm 20 at the wrist hinge 50 to control a pivot angle and/or rotational position of the first arm 20 relative to the wristband 12. The actuators 52 may include motors, gear reduction sets, linear actuators, servos, and/or other mechanical or electromechanical structure for pivoting and rotating the first arm 20 relative to wristband 12, e.g., to a certain pivot angle and/or rotational position and in response to a command from the ECU 32. The actuators 52 may be communicatively coupled with the ECU 32.

The third pressure point node 18 is included in the apparatus 10 to apply pressure to a certain point on a user of the apparatus 10. For example, when the wristband 12 is worn at a certain position on the wrist of the user and the second arm 22 of the apparatus 10 is in a certain configuration, the third pressure point node 18 may apply pressure to the inner frontier gate pressure point. The inner frontier gate pressure point is located about three finger-width down from the wrist crease on the inner forearm. The third pressure point node 18 may include a rubber protrusion, e.g., having a hemisphere shape. The third pressure point node 18 may be any other suitable shape and/or material sufficient for applying pressure at human pressure points. The third pressure point node 18 is attached to the second arm 22, e.g., at a distal end of the second arm 22. The third pressure point node 18 may be fixed to the distal end of the second arm 22, e.g., with adhesive, a fastener, interference fit, and/or other suitable structure.

The second arm 22 may include a plurality of segments 54 with an arm hinge 56 between each segment such that the second arm 22 can move with multiple degrees of freedom to position the third pressure point node 18. The segments 54 of the second arm 22 may be plastic, metal, or other material of sufficient strength and rigidity to perform as described herein. The plurality of segments 54 of the first arm 20 includes more segments 54 than the plurality of segments 54 of the second arm 22. In the example apparatus 10 shown in the FIGS., the second arm 22 includes two segments 54, e.g., to enable to the third pressure point node 18 to reach the inner frontier gate pressure point. It is to be understood that the second arm 22 may include more or less segments 54, e.g., two, four, etc.

The arm hinges 56 attached between the segments 54 permit pivot movement of the segment on one side of the arm hinge 56 relative to the segment on the other side of the arm hinge 56. The arm hinges 56 may only permit pivot movement upon application of sufficient force to one or more of the segments 54. For example, the arm hinges 56 may include fiction pads or other suitable structure that resists movement.

The apparatus 10 may include one or more actuators 58 configured to move the hinges 56 between the segments 54 of the second arm 22. For example, an actuator 58 may be at each of the hinges 56 of the second arm 22. The actuators 58 may include motors, gear reduction sets, linear actuators, servos, and/or other mechanical or electromechanical structure for pivoting one segment 54 relative to another segment 54 about the hinge 56 therebetween, e.g., to a certain pivot angle and/or rotational position and in response to a command from the ECU 32. The actuators 58 may be communicatively coupled with the ECU 32.

The second arm 22 is supported by the wristband 12. In other words, weight of the second arm 22 is borne by the wristband 12. For example, the second arm 22 may be attached to the wrist hinge 50. The second arm 22 my pivot relative to the wristband 12 at the wrist hinge 50, and may rotate relative to the wristband 12 at the wrist hinge 50, e.g., as discussed above for the first arm 20. The wrist hinge 50 may only permit pivot and/or rotation movement upon application of sufficient force to the second arm 22, e.g., as discussed above for the first arm 20. The second arm 22 may be attached to the wristband 12 other than at the wrist, e.g., at another wrist hinge 50 (not shown).

The apparatus 10 may include one or more actuators 60 configured to move the second arm 22, e.g., at the wrist hinge 50 to control, a pivot angle and/or rotational position of the second arm 22 relative to the wristband 12. The actuators 60 may include motors, gear reduction sets, linear actuators, servos, and/or other mechanical or electromechanical structure for pivoting and rotating the first arm 20 relative to wristband 12, e.g., to a certain pivot angle and/or rotational position and in response to a command from the ECU 32. The actuators 60 may be communicatively coupled with the ECU 32.

The apparatus 10 may include pressure sensors 62 that detect pressures applied to the pressure point nodes 14, 16, 18. The pressure sensors 62 may include piezo resistive, piezoelectric, optical, capacitive, and elastoresistive sensors. For example and without limitation, one pressure sensor 62 may be supported by the strap 24 and positioned under the first pressure point node 14. Another pressure sensor 62 may be supported by the first arm 20 and configured do detect pressure applied to the second pressure point node 16. For example, such pressure sensor 62 may be fixed to the distal end of the first arm 20 and under the second pressure point node 16. Another pressure sensor 62 may be supported by the second arm 22 and configured do detect pressure applied to the third pressure point node 18. For example, such pressure sensor 62 may be fixed to the distal end of the second arm 22 and under the third pressure point node 18. The pressure sensors 62 may be communicatively coupled with the ECU 32.

With reference to FIG. 3, the communication unit 64 may be included to communicatively couple components of the apparatus 10 with each other, and/or communicatively couple the apparatus 10 with systems, devices, or the like that are remote from the apparatus 10. The communication unit 64 may include, for example, and without limitation, an antenna, a modem, LAN port, Wi-Fi card, WiMax card, Bluetooth hardware, IrDA hardware, Wireless USB hardware, Z-Wave hardware, ZigBee hardware, mobile communications hardware, near-field communication hardware, satellite communication hardware, cellular network communication hardware, and/or any wired or wireless hardware for communicating with other networks and/or devices. The cellular network may include, for example, and without limitation, a Global System for Mobile Communications (GSM) network, a 3G Universal Mobile Telecommunications System (UMTS) network, a 4G Long Term Evolution (LTE) network, a 5G network, and the like.

The ECU 32 is included in the apparatus 10, e.g., to control the actuators 42, 48, 52, 58, 60. The ECU 32 may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device. The ECU 32 may be supported by the wristband 12. For example, the ECU 32 may be disposed within a housing 66 of the base 26.

The non-transitory computer readable memory may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The ECU 32 may be communicatively coupled with the user interface 30. The user interface 30 receives input from a user, such as the user of the apparatus 10, and provides such input to the ECU 32. The user interface 30 may include one or more buttons, touch screens, or the like that convert user input to electronic information. The user interface 30 may be supported by the base 26. The user interface 30 may be remote from the base 26 and wristband 12 (not shown). For example, the user interface 30 may be a FOB with a plurality of buttons, a power source, one or more antenna for sending and receiving wireless information, etc. As another example, the user interface 30 may be a smart phone or the like having a software application for providing information to, and receiving information from, the ECU 32.

The ECU 32 is configured to, i.e., the memory of the ECU 32 stores instructions executable by the processor of the ECU 32 to, control the actuators 48 of the first arm 20 to move one of the segments 44 of the plurality of segments 44 of the first arm 20 relative to another of the segments 44 of the plurality of segments 44 of the first arm 20. Similarly, the ECU 32 may be configured to control the actuators 58 of the second arm 22 to move one of the segments 54 of the plurality of segments 54 of the second arm 22 relative to another of the segments 54 of the plurality of segments 54 of the second arm 22. The ECU 32 may also be configured to control the actuators 52,60 at the wrist hinge 50 to control a pivot and/or rotational position of the first arm 20 and/or the second arm 22 relative to the wristband 12. The ECU 32 may control the actuators 48, 52, 58, 60 by transmitting a command to the actuators 48, 52, 58, 60, e.g., specifying a certain position, a certain direction, etc.

The ECU 32 may be configured to, i.e., the memory stores instruction executable by the processor to, control the actuators 48, 52, 58, 60 based on information received from one or more of the pressure sensors 62. For example, the ECU 32 may command one or more of the actuators 48, 52, 58, 60 to increase or decrease one or more of the pivot angles PA until a pressure detected by one or more of the pressure sensors 62 is above a threshold, below a threshold, or between maximum and minimum thresholds. The various thresholds may be predetermined and stored in the ECU 32. The various thresholds may be provided by a user, e.g., via the user interface 30.

The ECU 32 is configured to set positions for the first arm 20 and/or the second arm 22. The set positions, e.g., certain pivot angles PA and/or the rotational positions RP at one or more of the hinges, may be stored in memory of the ECU 32. The electric control unit may be configured to set the set positions based on a current position of the first arm 20 and/or the second arm 22 and in response to receiving input from the user interface 30. For example and without limitation, the user may manually move the first arm 20 and/or the second arm 22 to desired positions, and then may intact with the user interface 30 to command the ECU 32 to store such positions as the set positions. The ECU 32 may be configured to set the positions based on a user hand size. For example, the ECU 32 may include a look-up table or the like that associates various hand shapes, sizes, etc., with various positions. The user may provide a specific hand shape, size, etc., e.g., via the user interface 30, to the ECU 32, and the ECU 32 may determine the set positions with such provided information and the look-up table.

The ECU 32 may be configured to control one or more of the actuators 48, 52, 58, 60 to move the first arm 20 and the second arm 22 to set positions. For example, the ECU 32 may command one or more the actuators 48, 52, 58, 60 to increase or decrease the pivot angles PA and/or change the rotational positions RP at one or more the of hinges 46, 56 to move the first arm 20 and the second arm 22 to set positions.

With reference to FIG. 4, the user may secure the wristband 12 around their wrist and position the strap 24, the first arm 20, and the second arm 22 such that the first pressure point node 14, the second pressure point node 16, and the third pressure point node 18 generally abut or apply pressure to the great abyss pressure point, the union valley pressure point, and the inner frontier gate pressure point. After the user has positioned the arms 20, 22 the user may interact with the user interface 30 to command the ECU 32 to store the positions of the first arm 20 and the second arm 22 as the set positions. The user may also interact with the user interface 30 to command the ECU 32 to actuate one or more of the actuators 42, 48, 52, 58, 60, e.g., to put additional pressure on the pressure points of the user and based on information from the pressure sensors 62. On subsequent uses of the apparatus 10, the user may secure the wristband 12 around their wrist and interact with the user interface 30 to command the ECU 32 to actuate one or more of the actuators 48, 52, 58, 60 to move the first arm 20 and the second arm 22 to the set positions. After the ECU 32 has moved the first arm 20 and/or the second arm 22 to the set position, the user may interact with the user interface 30 to command the ECU 32 to actuate one or more of the actuators 42, 48, 52, 58, 60, e.g., to put additional pressure on the pressure points.

From the above, it is to be appreciated that defined herein is a pressure point stimulation apparatus includes a wristband, one or more multi-segmented and hinged arms supported by the wristband, and a plurality of pressure point nodes supported by the wristband and/or arms, the pressure point stimulation apparatus wearable and adjustable by a user such that the plurality of pressure point nodes apply pressure to a plurality of pressure points of the user.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A pressure point stimulation apparatus, comprising:
a wristband;
a first pressure point node attached to the wristband;
an arm supported by the wristband, the arm having a plurality of segments with an arm hinge between each segment; and
a second pressure point node attached to the arm.

2. The pressure point stimulation apparatus of claim 1, further comprising a second arm supported by the wristband, the second arm having a plurality of segments with an arm hinge between each segment, and a third pressure point node attached to the second arm.

3. The pressure point stimulation apparatus of claim 2, wherein the plurality of segments of the arm includes more segments than the plurality of segments of the second arm.

4. The pressure point stimulation apparatus of claim 2, wherein the plurality of segments of the arm includes three segments and the plurality of segments of the second arm includes two segments.

5. The pressure point stimulation apparatus of claim 2, further comprising a wrist hinge attached to the wristband, and wherein the arm and the second arm are both attached to the wrist hinge.

6. The pressure point stimulation apparatus of claim 1, further comprising at least one actuator configured to actuate at least one hinge between the segments of the plurality of segments of the arm.

7. The pressure point stimulation apparatus of claim 6, further comprising an electronic control unit supported by the wristband and configured to control the actuator to move one of the segments of the plurality of segments of the arm relative to another of the segments of the plurality of segments of the arm.

8. The pressure point stimulation apparatus of claim 7, further comprising a pressure sensor supported by the arm and configured do detect pressure applied to the second pressure point node.

9. The pressure point stimulation apparatus of claim 8, wherein the electric control unit is configured to control the actuator based on information receive from the pressure sensor.

10. The pressure point stimulation apparatus of claim 7, wherein the electric control unit is configured to set a position for the arm and to control the actuator based on the set position.

11. The pressure point stimulation apparatus of claim 10, wherein the electric control unit is configured to set the position based on a user hand size.

12. The pressure point stimulation apparatus of claim 10, wherein the electric control unit is configured to set the position based on a currently position of the arm and in response to receiving input from a user interface.

13. The pressure point stimulation apparatus of claim 1, wherein the wristband can be actuated to increase pressure applied by the first pressure point node.

14. The pressure point stimulation apparatus of claim 12, wherein actuation of the wristband decreases a circumference of the wristband.

15. A pressure point stimulation apparatus, comprising:
a wristband;
a first arm supported by the wristband, the first arm having a plurality of segments with an arm hinge between each segment;
a first pressure point node attached to the arm;
a second arm supported by the wristband, the second arm having a plurality of segments with an arm hinge between each segment; and
a second pressure point node attached to the second arm.

16. The pressure point stimulation apparatus of claim 15, wherein the plurality of segments of the first arm includes more segments than the plurality of segments of the second arm.

17. The pressure point stimulation apparatus of claim 15, wherein the plurality of segments of the first arm includes three segments and the plurality of segments of the second arm includes two segments.

18. The pressure point stimulation apparatus of claim 15, further comprising a wrist hinge attached to the wristband, and wherein the first arm and the second arm are both attached to the wrist hinge.

19. The pressure point stimulation apparatus of claim 15, further comprising at least one actuator configured to actuate at least one hinge between the segments of the plurality of segments of the first arm.

20. The pressure point stimulation apparatus of claim 19, further comprising an electronic control unit supported by the wristband and configured to control the actuator to move one of the segments of the plurality of segments of the first arm relative to another of the segments of the plurality of segments of the first arm.
